(19) United States
(12) Patent Application Publication
(10) Pub. No.: US 2012/0316480 A1
(43) Pub. Date: Dec. 13, 2012

(54) THERAPEUTIC COMPRESSION APPARATUS

(75) Inventors: Timothy J. Nolan, South Salem, NY (US); Guy Osborne, Trumbull, CT (US); Sundaram Ravikumar, Briar Cliff Manor, NY (US); Vikram Ravikumar, Briar Cliff Manor, NY (US)

(73) Assignee: Sun Scientific, Inc., Dobbs Ferry, NY (US)

(21) Appl. No.: 13/444,600

(22) Filed: Apr. 11, 2012

Related U.S. Application Data
(63) Continuation-in-part of application No. 12/855,185, filed on Aug. 12, 2010.
(60) Provisional application No. 61/474,548, filed on Apr. 12, 2011.

(51) Int. Cl. A61H 7/00

(52) U.S. Cl. 601/151

(57) ABSTRACT

A compression garment includes a wrap member with a proximal end portion and opposed distal end portion. The wrap member is configured to wrap about at least a portion of a lower leg between calf and heel. The wrap member includes an inner sheet configured and adapted to be disposed facing the lower leg in use, and an outer sheet joined to the inner sheet with a leg compression bladder defined between the inner and outer sheets. The leg compression bladder is configured to compress at least a portion of the lower leg to augment venous return flow in the lower leg.

### CROSS-REFERENCE TO RELATED APPLICATIONS

This application is a continuation-in-part of co-pending application Ser. No. 12/855,185, filed Aug. 12, 2010. This application also claims benefit of priority from U.S. Provisional Application Ser. No. 61/474,548, filed Apr. 12, 2011. Each of these applications is incorporated by reference herein in its entirety.

### BACKGROUND OF THE INVENTION

1. Field of the Invention

The subject invention is directed generally to a device for applying compression to a limb, and more particularly, to a therapeutic device for applying compression to the lower leg of an individual in conjunction with the treatment of chronic venous insufficiency.

2. Description of Related Art

Normally, a healthy leg muscle squeezes the deep veins of the legs and feet to help move blood back to the heart. One-way valves in the deep leg veins keep blood flowing back towards the heart. However, prolonged periods of standing or sitting can cause the walls of the deep leg veins to stretch. Over time, in susceptible individuals, this can weaken the vein walls and damage the valves, causing blood to pool in the veins and increase venous blood pressure, resulting in chronic venous insufficiency (CVI).

Treatment of CVI typically involves the use compression stockings or medical hosiery to decrease chronic swelling. Compression stockings are elastic stockings that squeeze the veins to improve venous circulation and prevent excess retrograde blood flow. Compression stockings can also help to heal skin sores or stasis ulcers that often present in conjunction with CVI. It is also common to employ compression bandages to apply pressure to the leg. In this regard, a bandage is applied with constant tension so as to produce graduated compression with the highest pressure at the ankle. However, the technique is difficult and is often done by highly skilled caregivers.

Compression devices are used to assist in a large number of medical indications, mainly for preventing or otherwise reducing the occurrence of deep vein thrombosis (DVT) or other vascular disorders, such as Pulmonary Artery Disease (PAD), reducing the occurrence of edemas, and facilitating wound healing. For instance, persons subject to extended periods of bed rest or inactivity (e.g., post-operative recovery) are often susceptible to DVT, which is a clotting of venous blood in the lower extremities and/or pelvis. This clotting occurs due to the absence of muscular activity (stasis) in the lower extremities, which is required to pump the venous blood. Such clotting may also occur due to a local vascular injury or a hypercoaguble state. The condition can be life-threatening if a blood clot migrates to the lung, resulting in a pulmonary embolus or otherwise interfering with cardiovascular circulation.

Highly effective mechanical compression devices have also been developed for treating CVI, which are disclosed for example in U.S. Pat. Nos. 7,276,037 and 7,559,908, the disclosures of which are incorporated by reference herein in their entireties. These devices include a flexible wrap that carries a manually inflatable air bladder and is adapted to be securely positioned around the leg of an individual to apply localized pressure to a treatment site. The device also includes a fluid-filled wound dressing that can be applied directly to the skin for applying localized pressure and even a medicament to a venous ulcer when it is enveloped by the flexible wrap. While this device is effective for applying localized compression to the leg, it is not configured to apply localized compression to the foot to prevent swelling and further improve venous circulation.

Compression therapy is also necessary post-operatively with venous surgeries and procedures. After such surgeries, such as surgery of the saphenous vein, compression is needed for several days on the treated extremity in order to prevent hematoma formation and/or compression of the veins that have been treated with a liquid solution, mechanical means, laser or radio frequency energy treatments. Compression therapy can also be used to prevent or reduce the effects of deep vein thrombosis (DVT) and can lower the chances of developing postthrombotic syndrome

Current methods of providing post-operative compression typically include the manual application of bandages. The extremities are wrapped with the bandages to create compression. The bandaging is time consuming and the effectiveness is limited to the skill of the provider. In some instances, bandages are applied too tightly or too loosely and may slip from their intended position, decreasing their effectiveness. When this occurs, bandages must be taken off and reapplied, further increasing the time of application and decreasing the consistency of application of the therapy.

The apparatuses, methods and systems of the subject invention provide benefits and advantages that may overcome a number of problems with respect to known compression technologies. The subject invention provides an improvement over traditional technologies that employ post-operative compression bandages and tight-fitting therapeutic elastic garments, which cause patients discomfort and lose their elasticity and therefore their effectiveness over time.

The subject invention also overcomes the problems that arise due to the difficulty of applying current compression wrap technologies. The effectiveness of many traditional compression therapy is limited by the application of traditional systems. Because current compression therapy is done either with manual wraps or electromechanical systems, they require either a skilled medical processional to apply and/or the need for the patient to be stationary for extended periods of time. Although, stockings and/or bandages can be worn by patients and self-administered, they are very difficult for the patient to put on and pose a challenge for unskilled medical professionals to apply consistently and effectively.

Those skilled in the art will readily appreciate that it would be beneficial to provide a and further improve venous circulation, that may also be self-administered by a patient effectively.

Conventional methods and systems have generally been considered satisfactory for their intended purpose. However, there is still an need in the art for a therapeutic compression device for treating CVI that is adapted and configured to apply localized compression to the leg and foot to prevent swelling and further improve venous circulation, and that allows for improved ability to be self-administered by a patient. There also remains a need in the art for such a compression device that is easy to make and use. The present invention provides a solution for these problems.

### SUMMARY OF THE INVENTION

The subject invention is directed to a new and useful compression garment. The compression garment includes a wrap member with a proximal end portion and opposed distal end portion. The wrap member is configured to wrap about at least a portion of a lower leg between calf and heel. The wrap member includes an inner sheet configured and adapted to be disposed facing the lower leg in use, and an outer sheet joined to the inner sheet with a leg compression bladder defined between the inner and outer sheets. The leg compression bladder is configured to compress at least a portion of the lower leg to augment venous return flow in the lower leg.

In accordance with certain embodiments, the leg compression bladder is configured and adapted to expand to a preconfigured compression gradient profile when inflated. At least one spot weld connects the inner sheet and outer sheet of the wrap member to define the preconfigured compression gradient profile of the leg compression bladder. At least one linear weld connects the inner sheet to the outer sheet of the wrap member to define the preconfigured compression gradient profile of the leg compression bladder.

In certain embodiments, the inner sheet includes a layer that has a first elastic modulus, the inner sheet has a second elastic modulus, and the first elastic modulus is less than the second elastic modulus in at least a transverse direction relative to the proximal and distal end portions for wrapping the wrap member around the leg when the leg compression bladder is inflated.

In accordance with certain embodiments, the inner sheet is configured and adapted to directly contact the lower leg. The inner sheet includes a secondary sheet disposed on an inner surface thereof, configured and adapted to directly contact the lower leg in use. The secondary sheet can be a fabric layer, which is elastic in a first direction and inelastic in a second direction to curl the wrap member around the leg when the leg compression bladder is inflated.

In certain embodiments, a foot wrap is operatively attached to the distal end portion of the wrap member. A foot compression bladder is disposed within the foot wrap. The leg compression bladder and the foot compression bladder are pneumatically coupled.

In accordance with certain embodiments, an inflation port is disposed on the wrap member and pneumatically coupled to the leg compression bladder, and an inflation device is attached to the inflation port for inflation of the leg compression bladder. The inflation device can be detachable from the inflation port.

In certain embodiments, a relief valve is operatively connected to the leg compression bladder to protect from overinflation. The relief valve is set to open at a predetermined pressure. The relief valve can also be configured to open at a user selectable pressure. A vent valve is operatively connected to the leg compression bladder for deflation.

In accordance with certain embodiments, a compression garment includes a wrap member with a proximal end portion and opposed distal end portion, the wrap member configured to wrap about at least a portion of a lower leg between calf and heel. The wrap member includes an inner sheet to be disposed facing the lower leg, and an opposed outer sheet joined to the inner sheet with a continuous peripheral weld defining a leg compression bladder between the inner and outer sheets. The leg compression bladder is configured to compress at least a portion of the lower leg to augment venous return flow in the lower leg.

These and other features of the systems and methods of the subject invention will become more readily apparent to those skilled in the art from the following detailed description of the preferred embodiments taken in conjunction with the drawings.

### BRIEF DESCRIPTION OF THE DRAWINGS

So that those skilled in the art to which the subject invention appertains will readily understand how to make and use the devices and methods of the subject invention without undue experimentation, preferred embodiments thereof will be described in detail herein below with reference to certain figures, wherein:

FIG. 1 is a top plan view of an exemplary embodiment of a compression garment constructed in accordance with the present invention, showing the layout of through-holes, heel pad and ankle pad throughout the compression garment as viewed from the interior of the garment;

FIG. 2 is a bottom plan view of the compression garment of FIG. 1, showing the weld pattern to connect the outer sheet to the inner sheet defining a bladder within the inner and outer sheets as viewed from the exterior of the garment;

FIG. 3 is an exploded perspective view of the compression garment of FIG. 1, showing the layout of the outer sheet, the inner sheet and hook and loop closures;

FIG. 4 is a detailed cross-sectional view of the compression garment taken along line 4-4 of FIG. 1, illustrating the leg compression bladder in a deflated state;

FIG. 5 is a detailed cross-sectional view of the compression garment taken along line 4-4 of FIG. 1, illustrating the leg compression bladder in an inflated state;

FIGS. 6-7 are front perspective and medial perspective views, respectively, of the compression garment of FIG. 1 being worn on a lower leg; and

FIG. 8 is a detailed cross-sectional view of the compression garment taken along line 8-8 of FIG. 7, illustrating the leg compression bladder in an inflated state.

### DETAILED DESCRIPTION OF THE PREFERRED EMBODIMENTS

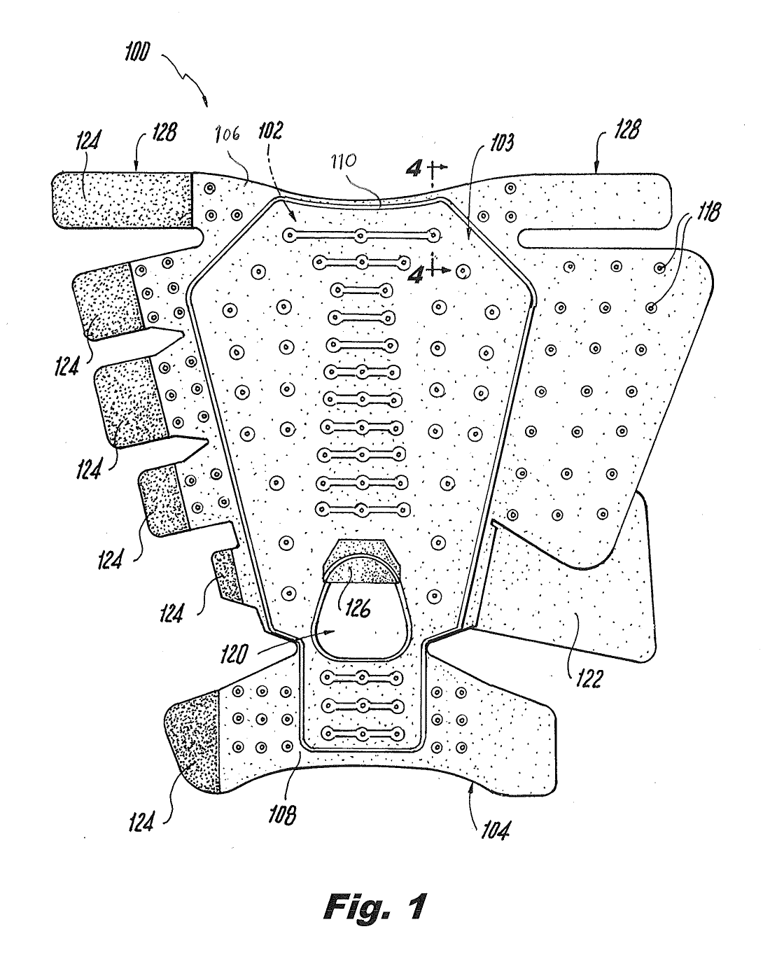

Reference will now be made to the drawings wherein like reference numerals identify similar structural features or aspects of the subject invention. For purposes of explanation and illustration, and not limitation, a partial view of an exemplary embodiment of the compression garment in accordance with the invention is shown in FIG. 1 and is designated generally by reference character 100. The system of the invention can be used to provide compression to the extremities of a patient, including for example, the lower leg and foot, in a manner that is simpler and more convenient than current systems.

In a traditional therapeutic compression system, an attached bladder or bladders placed within pockets of a generally inelastic material created compression by inflating the bladders in conjunction with the non-elastic garment. As the bladders fill, the garments provide counter-tension to the bladders and thereby compress a patient's lower leg. An example of a such a therapeutic compression system is described in U.S. patent application Ser. No. 12/855,185, the disclosure of which is incorporated by reference herein in its entirety. The subject invention provides a system for providing compression and preventing swelling of the foot of a patient using an integrally formed bladder configured to apply desired compression. The integrally formed bladder creates compression in a manner that allows for consistent measuring of the pressure supplied, as well as safe, comfortable, convenient, effective, and self-application by a patient. Advantages to providing a compression garment with an integrally formed bladder within the garment results in a device which is easier to construct and tailor the compression device to a desired compression profile.

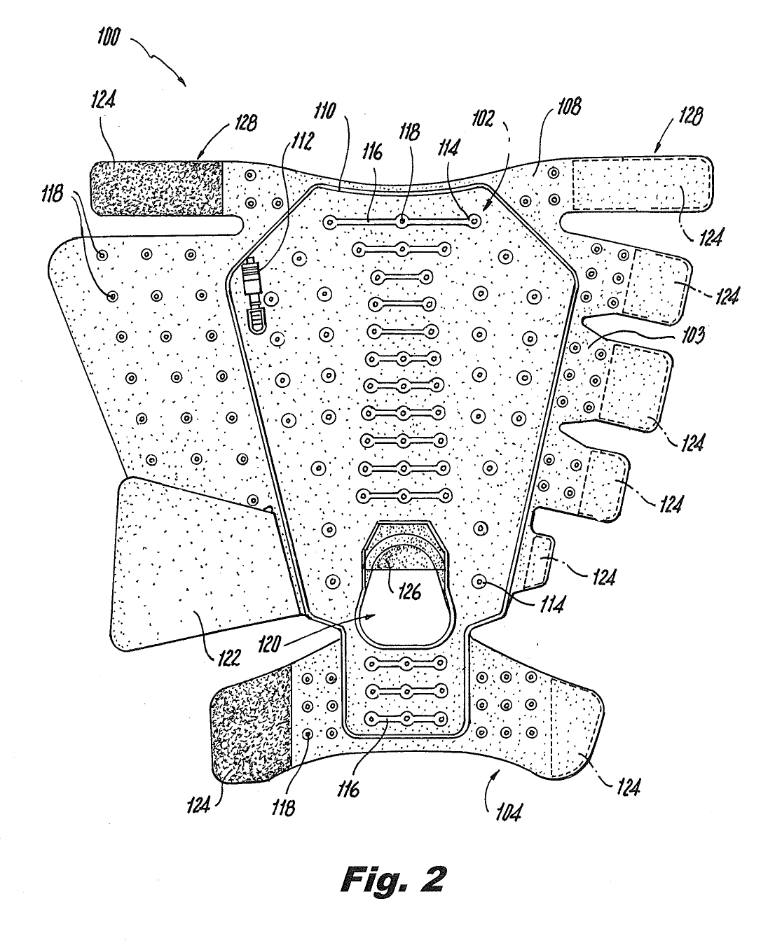

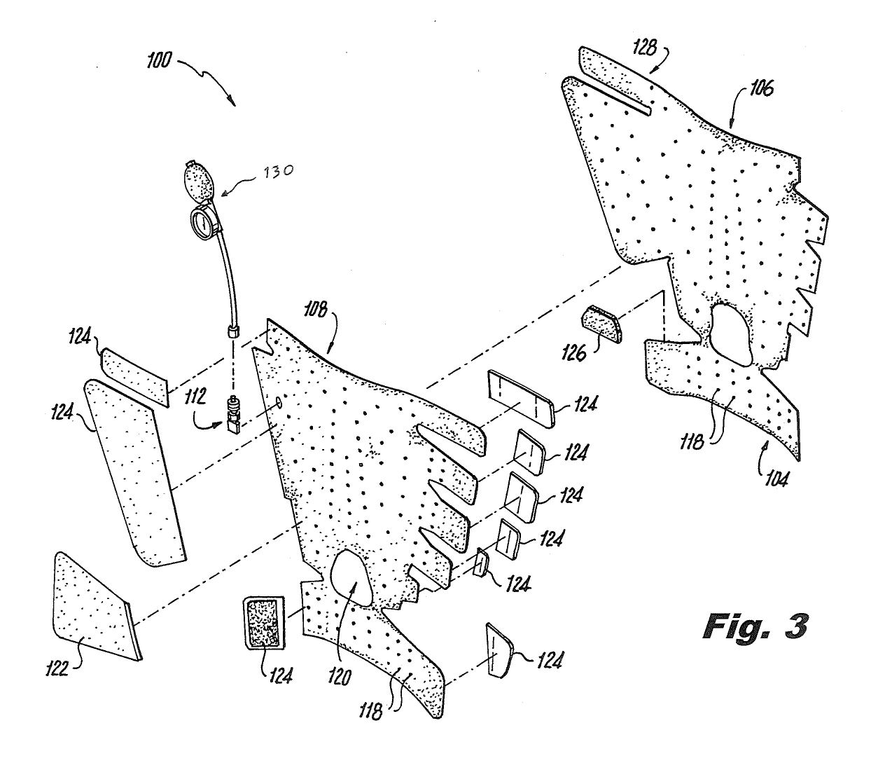

Referring to FIGS. 1-3, an exemplary embodiment of compression garment 100 constructed in accordance with the present invention, showing compression bladder 102 integrally formed in compression garment 100. Compression garment 100 is configured and adapted to wrap around a patient's lower leg through the use of calf wrap 103 and foot wrap 104 which are formed out of continuous outer sheet 108 and inner sheet 106. Compression garment 100 is a wrap member with a proximal end portion (top as oriented in FIGS. 1 and 2) and opposed distal end portion (bottom as oriented in FIGS. 1 and 2) which is configured and adapted to conform around a patient's lower leg and provide compression through the inflation of bladder 102. Inner sheet 106 and outer sheet 108 are made out of a nylon laminated polyurethane sheet which are configured and adapted to be RF welded together. However, any other suitable materials which are weldable or otherwise joined while being airtight can be used. Continuous peripheral weld line 110 forms an airtight boundary of integrally formed bladder 102. In this exemplary embodiment, bladder 102 is a single continuous bladder throughout the calf wrap 103 and foot wrap 104. However, it is envisioned that foot wrap 104 can have an independent bladder either separately inflatable or inflatable through a one-way valve or other desired inflation/deflation configuration. Foot wrap 104 can also be configured and adapted to provide a differing pressure from lower leg wrap 103. In an exemplary embodiment, bladder 102 located in foot wrap 104 is configured and adapted to be located along the underside of a patient's foot. Bladder 102 in foot wrap 104 can be adjusted as desired to provide compression to the desired part of a patient's foot.

Hook and loop fasteners 124 are provided along the edge of inner and outer sheets in order to ease adjustment and secure compression garment 100 on a patient's lower leg and foot. It is envisioned that compression garment 100 can also be secured to a patient's lower leg by other means, such as zippered, buttoned, or be cuff shaped by other such suitable means. Further, it is also envisioned that hook and loop closures 124 can be replaced by material similar to that of ankle strap 122 described below and be welded/sewn/attached to bladder 102 for improved comfort.

Inflation device 130 is a hand pump which can attach to inflation port 112 to inflate bladder 102. It can be appreciated that a mechanical or automatic inflation pump (not shown) can also be attached to inflation port 112 to inflate and deflate bladder 102 to provide pulsating pressure to a user's lower leg. A vent valve (not shown) can also be incorporated into compression garment 100 or with inflation device 130 to allow a user to selectively deflate bladder 102. Further, a relief valve (not shown) can also be incorporated with either inflation device 130 or bladder 102 to prevent overinflation once a maximum pressure is detected. Examples of relief valves are described in U.S. Pat. No. 7,276,037 and U.S. Pat. No. 7,850,629, the disclosures of which are incorporated by reference in their entirety.

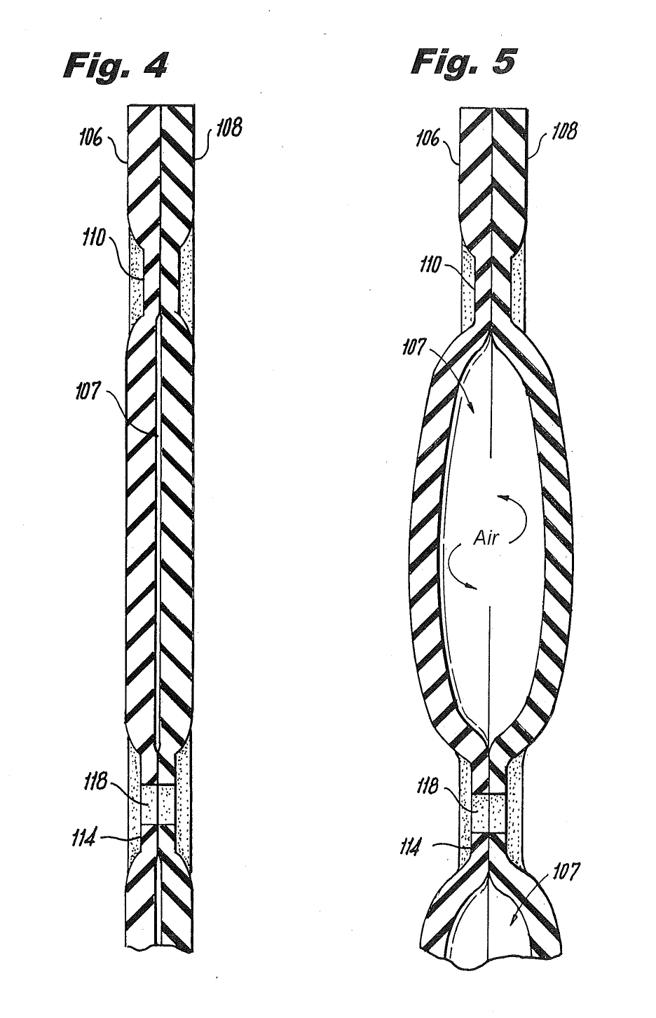

Referring now to FIGS. 4-5, by forming bladder 102 to be integral within inner sheet 106 and outer sheet 108, the location and desired preconfigured compression gradient profile can be obtained cost-effectively. A number of different embodiments of bladder configurations can be used in the compression garment of the subject invention such as those configurations described above. FIGS. 1 and 2 show compression garment 100 having bladder 102 with a plurality of spot welds 114 therein. Spot welds 114 are strategically placed within bladder 102 in a predetermined pattern based on the desired gradient profile relative to the compression needed at the patient's treatment site. Spot welds 114 enable bladder 102 to define the gradient profile when inflated through inflation port 112. The geometric placement of spot welds 114 within bladder 102 allows increased inflation of certain portions of bladder 102, and can create one or more fluid chambers within bladder 102. This configuration is particularly useful when compression is needed to improve fluid movement (e.g., blood, lymph, etc.) within the body. Further, linear weld lines 116 allow for better compression along the back of a patient's calf by increasing tension applied to the back of the calf of a patient. This increased tension can generate a more effective calf compression in order to increase venous flow. Linear weld lines 116 located laterally along the back of the calf create a ribbed portion, which keeps the inflated profile of compression garment 100 compact which can further increase ambulation and reduce interference with a patient's clothes. Foot wrap 104 can also be made from an elastic garment without bladder 102.

It can be appreciated that depending on the location of the compression garment, different pressure gradients may be utilized. Examples of other bladder pressure gradient profiles are described in U.S. patent application Ser. No. 12/911,563 and U.S. patent application Ser. No. 12/855,185, the disclosures of which are incorporated by reference in their entirety.

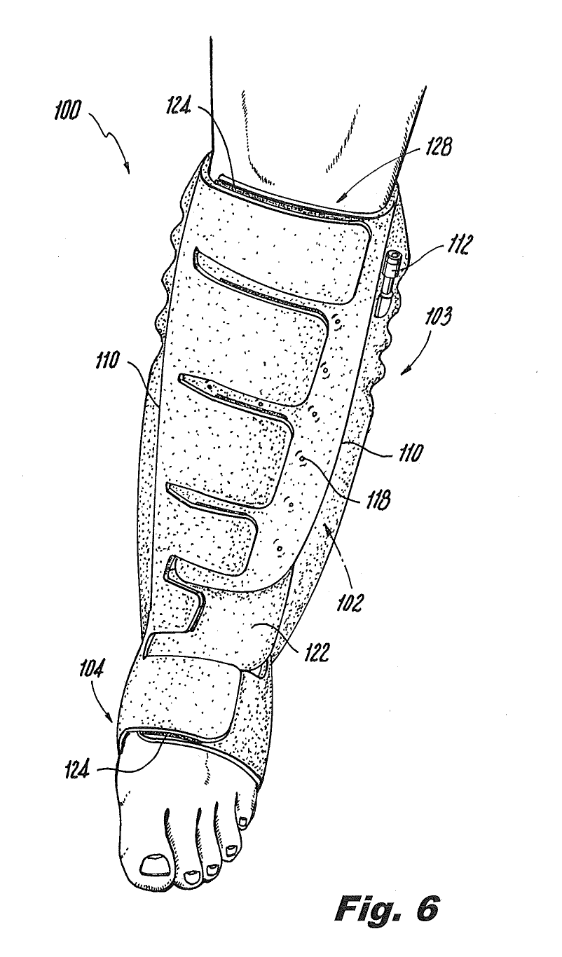

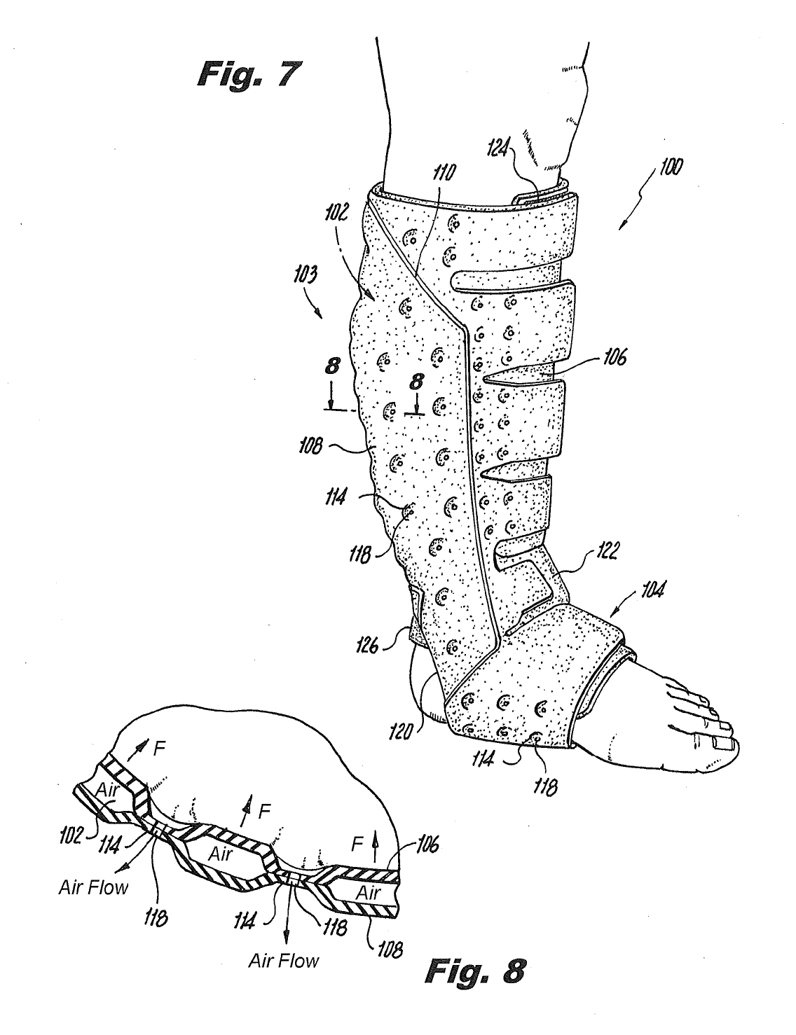

Referring now to FIGS. 6-7, once compression garment 100 is secured around a patient's lower leg, bladder 102 is not able to shift out of place, thus increasing comfort and reducing fitting issues on the patient. In order to increase the ease of ambulation by a patient, in an exemplary embodiment, ankle cushion 126 can be attached adjacent heel port 120 to prevent the occurrence of a pinch point and reduce pressure on a patient's Achilles tendon. In combination with ankle cushion 126, ankle strap 122 can be used. In an exemplary embodiment, ankle strap 122 can include non-elastic foam which prevents a pinch point at the bottom of lower leg wrap 103 and the upper part of foot wrap 104. A further advantage to providing ankle strap 122 is that bladder 102 proximate ankle strap 122 is pulled tight against a patient's leg and improves compression near the heel of a patient. Ankle strap 122 is advantageously wrapped around the patient's ankle and foot prior to affixing hook and loop fasteners 124. In order to improve comfort, through-holes 118, as seen in FIG. 8, are located throughout compression garment 100 in order to allow for ventilation about a patient's leg during extended wear of compression garment 100. For the sake of clarity, not all of the through-holes 118 are identified with reference characters in the Figures.

In accordance with an exemplary embodiment, inner sheet 106 further includes a layer (not shown) that has a first elastic modulus, inner sheet 106 has a second elastic modulus. The first elastic modulus is less than the second elastic modulus in a transverse direction relative to the proximal and distal end portions of compression garment 100 to wrap compression garment 100 around the leg when the leg compression bladder is inflated. In an exemplary embodiment, inner sheet 106 includes a secondary sheet (not shown) disposed on an inner surface thereof, to directly contact the lower leg in use. The secondary sheet can be a fabric layer, which is elastic in a first direction and inelastic in a second direction to curl the wrap member around the leg when the leg compression bladder is inflated.

pIn an exemplary embodiment, upper leg strap 128 is configured and adapted to improve wearability of compression garment 100 by locating a portion of bladder 102 above the widest portion of the calf of a patient and provides stability of compression garment 100 by preventing compression garment 100 from slipping down the lower leg of a patient which would make compression garment 100 ineffective in providing calf compression.

The present invention has been illustrated and described with respect to specific embodiments thereof, which embodiments are exemplary and illustrative of the principles of the invention and are not intended to be exclusive or otherwise limiting embodiments. For instance, while in the foregoing embodiments the compression garments are described as having inflatable bladders, the compression garments may additionally include integrally formed or attached (e.g., by adhesive, radio-frequency welding, etc.) compression members that are not configured for inflation and/or deflation. For instance, additional compression members may be implemented using any of a variety of preformed and/or prefilled cushioning materials such as foam cushions and/or air, gel, or other fluid filled non-inflatable cushions, provided such compression members generate sufficient compression in combination with integral compression bladders. Further, while particular shapes, sizes, and materials have been described for purposes of illustration, it will be recognized that any of a variety of shape or size can be used, and the materials described are not exclusive but merely illustrative. Also, as noted above, while the bladder shown is inflated with air, it will be appreciated that any other fluid or medium such as liquid or gel can be used. Moreover, as also noted, it will be understood that bladders may be configured to have multiple pneumatically independent and/or pneumatically coupled bladder sections, and may also be configured to have various contours or lobulations.

The compression garments described herein can be used for any suitable condition treatable by compression therapy and the like. For example, compression garments in accordance with the present invention can be used for compression of the venous system for the treatment of venous ulcers, for the treatment of lymphedema (where it is circulation of fluids in the lymph system rather than in the venous system that is promoted), and the like.

The methods and systems of the present invention, as described above and shown in the drawings, provide for compression therapy with superior properties including ease of construction and ease of use by a patient. While the apparatus and methods of the subject invention have been shown and described with reference to preferred embodiments, those skilled in the art will readily appreciate that changes and/or modifications may be made thereto without departing from the spirit and scope of the subject invention.

What is claimed is:

1. A compression gall lent, comprising:
a wrap member with a proximal end portion and opposed distal end portion, the wrap member being configured to wrap about at least a portion of a lower leg between calf and heel, the wrap member including:
an inner sheet configured and adapted to be disposed facing the lower leg in use; and
an outer sheet joined to the inner sheet with a leg compression bladder defined between the inner and outer sheets, the leg compression bladder being configured to compress at least a portion of the lower leg to augment venous return flow in the lower leg.

2. A compression garment as recited in claim 1, wherein the leg compression bladder is configured and adapted to expand to a preconfigured compression gradient profile when inflated.

3. A compression garment as recited in claim 2, further comprising at least one spot weld connecting the inner sheet and outer sheet of the wrap member to define the preconfigured compression gradient profile of the leg compression bladder.

4. A compression garment as recited in claim 2, further comprising at least one linear weld connecting the inner sheet to the outer sheet of the wrap member to define the preconfigured compression gradient profile of the leg compression bladder.

5. A compression garment as recited in claim 1, wherein the inner sheet includes a layer that has a first elastic modulus, the inner sheet has a second elastic modulus, and wherein the first elastic modulus is less than the second elastic modulus in at least a transverse direction relative to the proximal and distal end portions for wrapping the wrap member around the leg when the leg compression bladder is inflated.

6. A compression garment as recited in claim 1, wherein the inner sheet is configured and adapted to directly contact the lower leg.

7. A compression garment as recited in claim 1, wherein the inner sheet includes a secondary sheet disposed on an inner surface thereof, the secondary sheet being configured and adapted to directly contact the lower leg in use.

8. A compression garment as recited in claim 7, wherein the secondary sheet is a fabric layer, the fabric layer being elastic in a first direction and inelastic in a second direction to curl the wrap member around the leg when the leg compression bladder is inflated.

9. A compression garment as recited in claim 1, further comprising a foot wrap operatively attached to the distal end portion of the wrap member, the foot wrap having a foot compression bladder disposed within the foot wrap.

10. A compression garment as recited in claim 9, wherein the leg compression bladder and the foot compression bladder are pneumatically coupled.

11. A compression garment as recited in claim 1, further comprising:
an inflation port disposed on the wrap member and pneumatically coupled to the leg compression bladder; and
an inflation device attached to the inflation port for inflation of the leg compression bladder.

12. A compression garment as recited in claim 11, wherein the inflation device is detachable from the inflation port.

13. A compression garment as recited in claim 1, further comprising a relief valve operatively connected to the leg compression bladder to protect from overinflation.

14. A compression garment as recited in claim 13, wherein the relief valve is set to open at a predetermined pressure.

15. A compression garment as recited in claim 13, wherein the relief valve is configured to open at a user selectable pressure.

16. A compression garment as recited in claim 1, further comprising a vent valve operatively connected to the leg compression bladder for deflation.

17. A compression garment, comprising:
a wrap member with a proximal end portion and opposed distal end portion, the wrap member being configured to wrap about at least a portion of a lower leg between calf and heel, the wrap member having:
an inner sheet to be disposed facing the lower leg; and
an opposed outer sheet joined to the inner sheet with a continuous peripheral weld defining a leg compression bladder between the inner and outer sheets, the leg compression bladder being configured to compress at least a portion of the lower leg to augment venous return flow in the lower leg.

18. A compression garment as recited in claim 17, wherein the leg compression bladder is configured and adapted to expand to a preconfigured compression gradient profile when inflated.

19. A compression garment as recited in claim 17, further comprising at least one spot weld and at least one linear weld connecting the inner sheet and outer sheet of the wrap member to define the preconfigured compression gradient profile of the leg compression bladder.

20. A compression garment as recited in claim 17, further comprising a foot wrap operatively attached to the distal end portion of the wrap member, the foot wrap further comprising a foot compression bladder disposed within the foot wrap.
